(19) United States
(12) Patent Application Publication
(10) Pub. No.: US 2026/0223131 A1
(43) Pub. Date: Jul. 30, 2026

(54) SWITCHING MECHANISMS FOR PHYSICAL DOWNLINK CONTROL CHANNEL USER EQUIPMENT ADAPTATION

(71) Applicant: QUALCOMM Incorporated, San Diego, CA (US)

(72) Inventors: Weimin DUAN, San Diego, CA (US); Hyojin LEE, San Diego, CA (US); Gabi SARKIS, San Diego, CA (US); Yu ZHANG, San Diego, CA (US); Sibasish DAS, San Diego, CA (US); Jing JIANG, San Diego, CA (US); Diana MAAMARI, San Diego, CA (US)

(21) Appl. No.: 19/038,052

(22) Filed: Jan. 27, 2025

(51) Int. Cl. H04W 72/232; H04L 5/00

(52) U.S. Cl. CPC H04W 72/232; H04L 5/0051

(57) ABSTRACT

The apparatus at a user equipment (UE) comprises at least one memory, and at least one processor coupled to the at least one memory and, based at least in part on information stored in the at least one memory, the at least one processor is configured to monitor for downlink communication based on a first reception mode associated with a first number of receive antennas, receive an indication to switch from the first reception mode to a second reception mode to monitor for the downlink communication. The second reception mode is associated with a second number of receive antennas different from the first number of receive antennas. The at least one processor is further configured to monitor for the downlink communication based on the second reception mode in accordance with the indication.

### TECHNICAL FIELD

The present disclosure relates generally to communication systems and, more specifically, to techniques for dynamically switching the reception mode of a user equipment (UE) based on network indications.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus comprises at least one memory, and at least one processor coupled to the at least one memory and, based at least in part on information stored in the at least one memory, the at least one processor is configured to monitor for downlink communication based on a first reception mode associated with a first number of receive antennas, receive an indication to switch from the first reception mode to a second reception mode to monitor for the downlink communication. The second reception mode is associated with a second number of receive antennas different from the first number of receive antennas. The at least one processor is further configured to monitor for the downlink communication based on the second reception mode in accordance with the indication.

In an aspect of the disclosure, a method, a computer-readable medium, and an apparatus are provided. The apparatus comprises at least one memory, and at least one processor coupled to the at least one memory and, based at least in part on information stored in the at least one memory, the at least one processor is configured to transmit an indication for a user equipment (UE) to switch from a first reception mode to a second reception mode in accordance with the indication to monitor for downlink communication. The first reception mode is associated with a first number of receive antennas at the UE, and the second reception mode is associated with a second number of receive antennas at the UE that is different from the first number of receive antennas. The at least one processor is further configured to transmit the downlink communication to the UE based on the second reception mode.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE having a plurality of antennas.

FIG. 5 is a diagram illustrating an example of a reception mode switching for monitoring downlink communication.

FIG. 6 is a diagram illustrating another example of a reception mode switching for monitoring downlink communication.

FIG. 7 is a diagram illustrating a further example of a reception mode switching for monitoring downlink communication.

FIG. 8A and FIG. 8B are diagrams illustrating an example of a dynamic reception mode switching for monitoring downlink communication, in accordance with various aspects of the present disclosure.

FIG. 9A is a diagram illustrating another example of a dynamic reception mode switching for monitoring downlink communication, in accordance with various aspects of the present disclosure.

FIG. 9B is a diagram illustrating an example feedback timeline for reporting the reception of the indication, in accordance with various aspects of the present disclosure.

FIG. 10 is a call diagram illustrating an example of a dynamic reception mode switching for monitoring downlink communication, in accordance with various aspects of the present disclosure.

FIGS. 11A and 11B are flowcharts of a method of wireless communication at a UE, in accordance with various aspects of the present disclosure.

FIG. 12 is a flowchart of a method of wireless communication at a network node, in accordance with various aspects of the present disclosure.

FIG. 13 is a diagram illustrating an example of a hardware implementation for an example apparatus and/or network entity.

FIG. 14 is a diagram illustrating an example of a hardware implementation for an example network entity.

FIG. 15 is a diagram illustrating an example of a hardware implementation for an example network entity.

### DETAILED DESCRIPTION

Various aspects relate generally to wireless communication systems and, more specifically, to techniques for dynamically switching the reception mode of a user equipment (UE) based on network indications. In some examples, the UE may start with monitoring downlink communication in a first reception mode, which is associated with a first number of receive antennas. Upon receiving an indication to switch reception modes, the UE may transition to a second reception mode, associated with a second number of receive antennas, different from the first number of receive antennas, for monitoring for the downlink communications. The first reception mode may include use of a reduced number of receive antennas in comparison to the second reception mode, and may enable power savings at the UE. In some aspects, the UE may use the first and second reception modes within the same bandwidth part (BWP) and switch to using the second reception mode without a BWP switch. In some aspects, the indication that triggers the UE to change to the second reception mode may include a physical downlink control channel (PDCCH) transmission, a DCI, a DL grant, and/or a measurement that indicates for the UE to switch to the second reception mode following reception of the PDCCH transmission until a timer expires. The UE may switch from the second reception mode to return to the first reception mode after expiration of the timer following the reception of the PDCCH transmission. In some aspects, the indication may correspond to a downlink grant or a downlink control information (DCI) indicated in a PDCCH transmission. In some aspects, the indication may be based on a physical downlink shared channel (PDSCH) demodulation reference signal (DMRS) configuration. Additionally or alternatively, the indication may correspond to an occurrence of one or more conditions triggering the switch from the first reception mode to the second reception mode that are configured for the UE. For example, the one or more conditions may correspond to one or more of a signal to noise ratio (SNR) measurement of the downlink communication that meets an SNR threshold, a reference signal received power (RSRP) measurement that meets an RSRP threshold, or a search space indication for a search space having an aggregation level (AL) associated with the second reception mode.

In some aspects, upon receiving the indication, the UE may switch from control monitoring mode (e.g., the first reception mode) with fewer antennas (e.g., 1 or 2) to conserve power, to an communication monitoring mode (e.g., the second reception mode) with more antennas (e.g., 4, 6, or 8), to monitor downlink communication more effectively. In some aspects, the indication is received at least an offset before a corresponding downlink transmission (e.g., a payload portion of the downlink communication) for reception with the second number of receive antennas.

In some aspects, receiving the indication may also configure the UE to switch from monitoring downlink communication with more antennas (e.g., 4, 6, or 8) to fewer antennas (e.g., 1 or 2) to conserve power.

Particular aspects of the subject matter described in this disclosure can be implemented to achieve one or more potential advantages. For example, the described techniques maintain UE power efficiency during control monitoring phases (e.g., monitoring PDCCH transmissions with fewer antennas), while ensuring optimized data decoding performance during data transmission phases by dynamically activating additional antennas as needed (e.g., monitoring PDSCH transmissions with more antennas). By leveraging dynamic switching mechanisms based on indications such as downlink grants, DCI instructions, meeting one or more configured conditions (e.g., SNR thresholds, reference signal received power (RSRP) thresholds, and/or aggregation levels), or transmissions configured in the PDSCH DMRS configurations, the technical solutions disclosed herein enable prompt and dynamic reception mode switching, providing flexible and efficient antenna usage tailored to real-time network conditions, thereby enhancing the overall robustness of the communication system.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

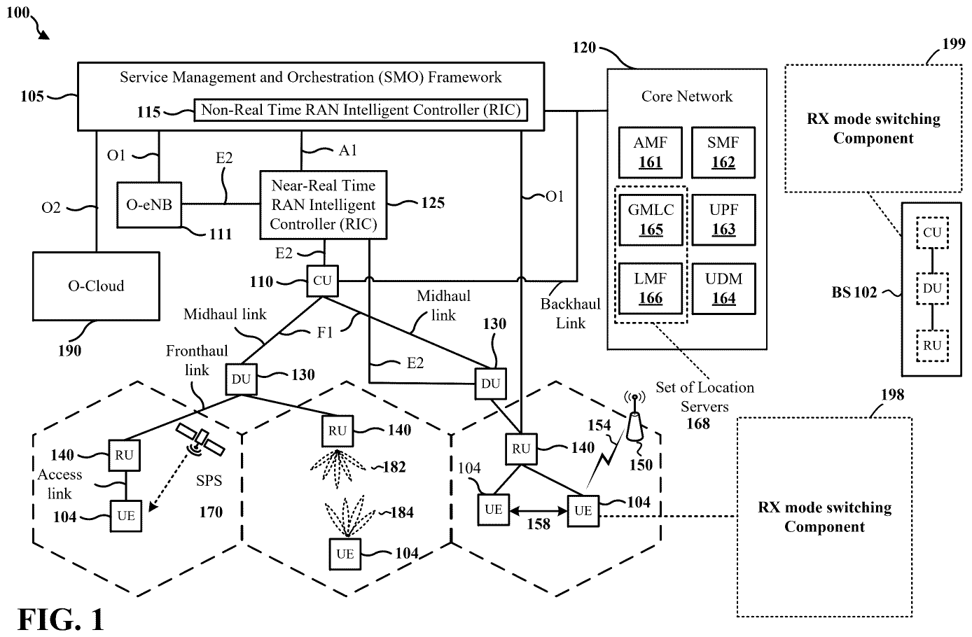

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an RX mode switching component 198 that may be configured to dynamically switch between different reception modes based on an indication, such as a downlink grant, DCI instruction, or one or more configured conditions (e.g., SNR thresholds, RSRP thresholds, and/or aggregation levels). In certain aspects, the base station 102 may have an RX mode switching component 199 that may be configured to configure the UE to dynamically switch between different reception modes based on the indication. The dynamic adaptation for RX mode switching disclosed herein enables flexible and efficient antenna usage tailored to real-time network conditions, thereby enhancing the overall robustness of the communication system.

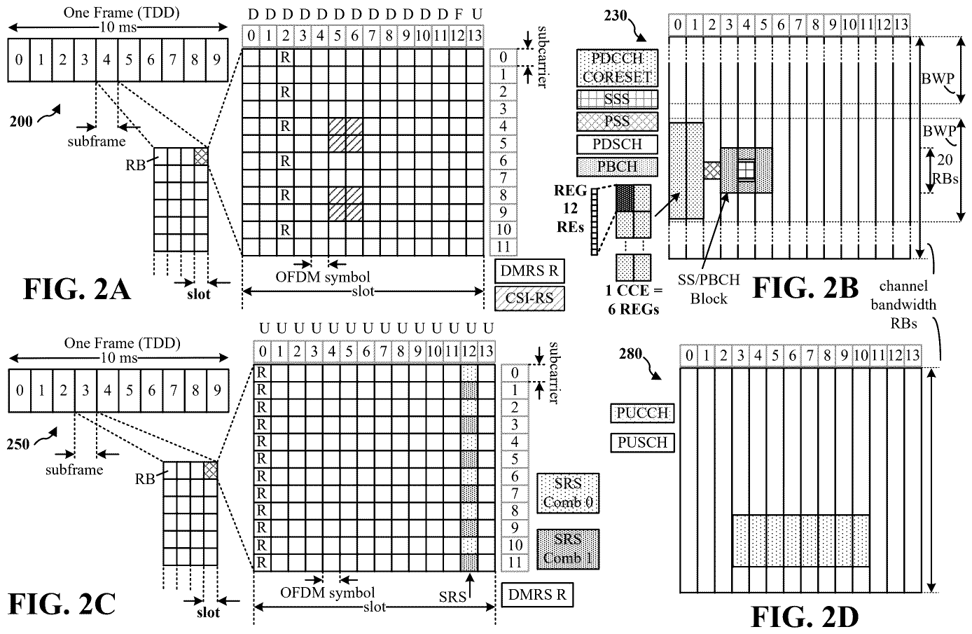

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

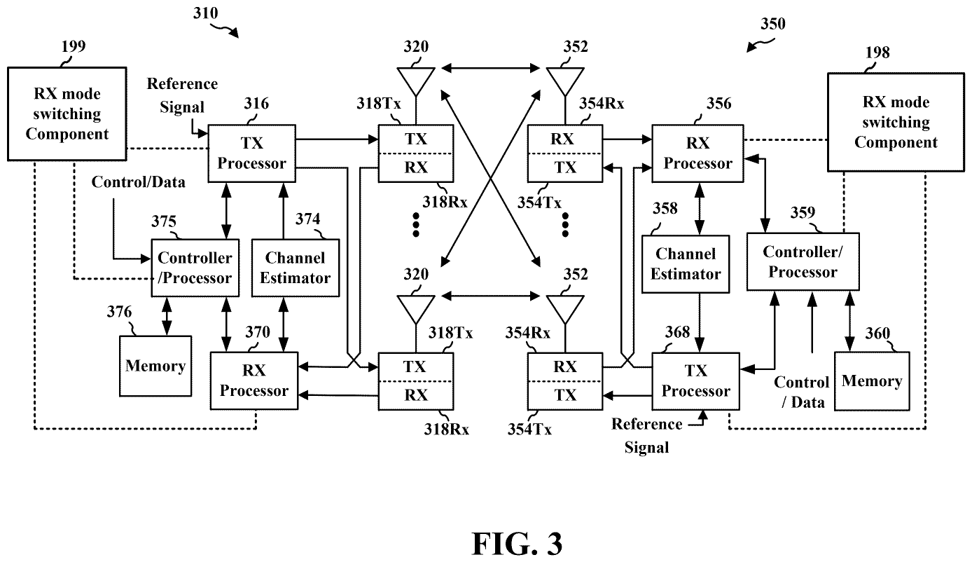

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the RX mode switching component 198 of FIG. 1.

At least one of the TX processor 316, the RX processor 370, and the controller/processor 375 may be configured to perform aspects in connection with the RX mode switching component 199 of FIG. 1.

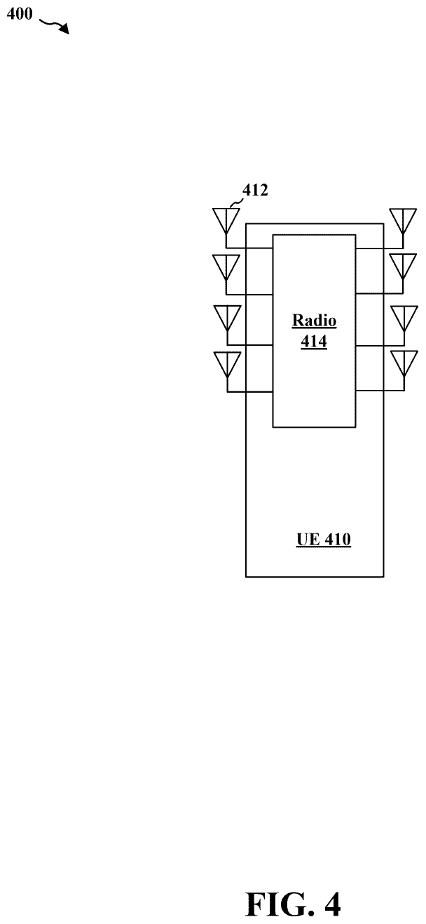

FIG. 4 is a diagram 400 illustrating an example UE 410 equipped with a plurality of antennas 412 coupled to a radio 414 for performing radio frequency (RF) functions. It is contemplated that the number of antennas 412 shown in FIG. 4 is for illustrative purposes only. Other possible configurations of antennas 412 (e.g., a total of 4 or 6 antennas) may also be applicable.

In some aspects, the radio 414, also referred to as the main radio, may be configured to receive control information (e.g., PDCCH transmissions) and/or data transmissions (e.g., PDSCH transmissions) under different reception modes. For example, the radio 414 may monitor downlink transmissions in a first mode using a smaller number of antennas 412 (e.g., 1 or 2 antennas) or in a second mode using a greater number of antennas 412 (e.g., 4, 6, or 8 antennas). In some aspects, the first mode may be configured to monitor control signals (e.g., PDCCH transmissions), and while operating in the first mode, the UE may function in an idle mode to conserve power. The second mode may be configured to monitor user data transmissions (e.g., PDSCH transmissions), with the UE functioning in an active mode to enable improved decoding of communication data (e.g., video, web content, etc.). The switching of reception modes allows the UE to balance power efficiency during control monitoring and enhanced performance during data reception.

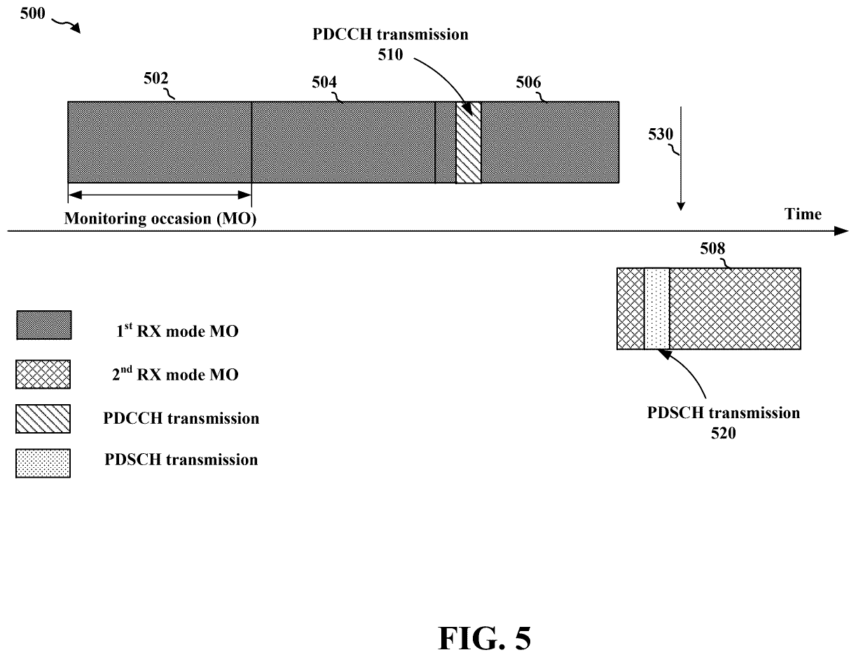

For example, FIG. 5 is a diagram 500 illustrating an example of a reception mode switching for monitoring downlink communication. In some aspects, the switching may be referred to as UE RX adaptation or PDCCH UE RX adaptation. As described above, a UE (e.g., the UE 410 in FIG. 4) may operate in a first reception mode associated with a fewer number of receive antennas (e.g., monitoring downlink transmissions with one antenna 412, e.g., which may be referred to as 1Rx) for control information monitoring (e.g., PDCCH monitoring) during first RX mode monitoring occasions (MOs) 502, 504, 506 in time. As an example, the first RX mode may be a 1Rx mode, and the second RX mode may be an 8Rx mode. As another example, the first RX mode may be a 2Rx mode, and the second RX mode may be an 8Rx mode. As an example, the first RX mode may be a 1Rx mode, and the second RX mode may be an 4Rx mode. These examples are merely described to illustrate the concept of a first Rx mode using a first number of Rx antennas, and a second Rx mode using an increased number of Rx antennas. Based on a configuration signaled to a UE and/or defined rules (e.g., which may be defined in a wireless standard), the UE may switch to a second reception mode at a particular (e,g, configured or defined) time point after receiving control information (e.g., a PDCCH transmission 510). As an example, the switch to the second reception mode may be based on reception of the PDCCH transmission 510. The second reception mode is associated with a greater number of receive antennas (e.g., monitoring downlink transmissions with all available antennas 412, 8Rx) for monitoring and decoding potential user data transmissions (e.g., a PDSCH transmission 520) during monitoring occasion(s) 508 following the change to the second RX mode.

In some aspects, the switch from 1Rx to 8Rx may be based on defined logic or fixed transition states, rather than being dynamically triggered. As an example, the time point in the process for the switch to the second RX mode after receiving control information may be independent of a specific configuration indicated by the control information. As an example, the UE may switch to an 8Rx mode for the monitoring occasion 508, even if the PDCCH transmission 510 does not indicate an 8Rx mode. Aspects presented herein provide for greater adaptability, to provide greater efficiencies, and avoid delayed transitions and/or resource overuse. For instance, if the PDSCH data arrives earlier than a transition point (e.g., when the UE has transitioned to 8Rx and is reading to receive the downlink transmission), the UE may fail to decode the PDSCH data properly. For example, FIG. 5 illustrates an example transition point 530 at which the UE may have finished the transition to 8Rx. As 530 is illustrated after the PDSCH transmission 520, the UE is not able to receive the PDSCH transmission 520. Additionally, if the UE remains in the 8Rx mode longer than necessary (e.g., when no PDSCH transmissions are anticipated for a duration of time), the UE may consume additional power.

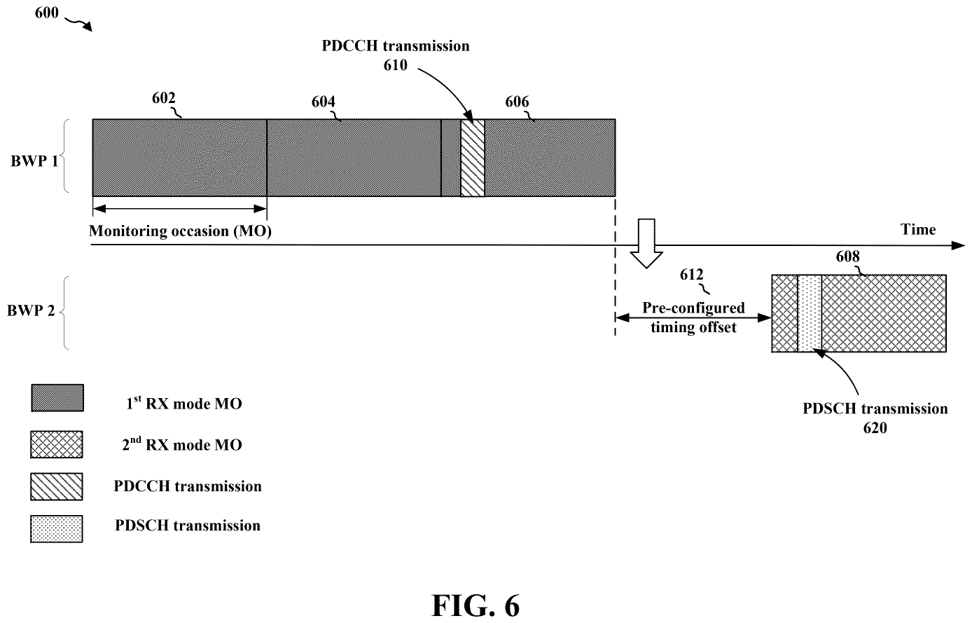

FIG. 6 is a diagram 600 illustrating another example of a reception mode switching for monitoring downlink communication in connection with a BWP switch. As shown in diagram 600, a UE (e.g., the UE 410 in FIG. 4) may switch between different reception modes based on configured rules and/or defined parameters, such as in connection with BWP switching. As an example, the first RX mode may be a 1Rx mode, and the second RX mode may be an 8Rx mode. As another example, the first RX mode may be a 2Rx mode, and the second RX mode may be an 8Rx mode. As an example, the first RX mode may be a 1Rx mode, and the second RX mode may be an 4Rx mode. These examples are merely described to illustrate the concept of a first Rx mode using a first number of Rx antennas, and a second Rx mode using an increased number of Rx antennas.

As an example, the UE may be in a low-power reception mode, such as using a single antenna (e.g., one antenna 412, 1Rx) to monitor for PDCCH transmissions with control information such as scheduling grants or DCI. The UE may monitor using the single RX antenna during RX mode monitoring occasions 602, 604, and 606, for example. This low-power mode may be designed for energy efficiency during idle periods or control monitoring phases, ensuring minimal power consumption, for example.

When a PDCCH transmission 610 is received (e.g., using 1Rx antenna), and the PDCCH transmission indicates a switch to BWP 2 (e.g., through control information such as DCI or a downlink grant), the UE may initiate the BWP switch. The UE may remain in the 1Rx mode while processing the PDCCH transmission 610, for example, and may switch to BWP 2 and a different RX mode such as 8Rx). The BWP 1 may have a max rank=1, where the rank indicates the number of spatial layers used for communication. For example, a max rank of 1 corresponds to a single spatial stream for simplified transmission. Switching from BWP 1 to BWP 2 (e.g., with a max rank=4, where the UE is capable of utilizing up to four spatial streams for higher data throughput) prepares the UE to receive data transmission in a different frequency or bandwidth configuration. In connection with the BWP switch, the UE transitions to a higher-capacity reception mode (4Rx or 8Rx). The UE monitors for downlink transmissions using the second RX mode during the following monitoring occasion(s) 608 to receive and decode data on the PDSCH.

Although this semi-dynamic change enables the UE to use additional antennas for improved data decoding performance, the timing of the transition may not be dynamically adapted to the arrival of the PDSCH data. Instead, the timing of the change to the second RX mode may be based on the configured BWP switch process (e.g., a BWP switch time) without accounting for the timing of the PDSCH data arrival.

The timing offset 612 is provided between the reception of control information and the subsequent reception mode switch, e.g., and may be a configured timing offset. For instance, the timing offset may include a period of time for channel state information (CSI) measurement and reporting in connection with the BWP siwtch. As one non-limiting example, the timing offset may be greater than 2.5 ms to allow the UE time to be ready to receive in a different BWP. The timing offset 612 accounts for the additional time for the UE to measure the channel state after receiving control information (e.g., PDCCH or DCI), process the measurement, prepare the CSI report, and transmit the CSI report back to the base station.

The timing offset introduces latency in the reception mode switching process. For instance, if the PDSCH data (e.g., PDSCH transmission 620) arrives earlier than the timing offset 612 completes, the UE may fail to fully prepare for decoding, leading to missed or degraded data decoding performance. Conversely, if the UE remains in the higher-capacity mode (e.g., 4Rx or 8Rx) longer—such as when no further data transmissions are anticipated—the UE may unnecessarily consume additional power, thereby reducing its energy efficiency. Because the transition to the higher-capacity reception mode (e.g., 4Rx mode or 8Rx mode) is triggered based on the BWP switch and includes configured timing parameters rather than dynamically adapting to the real-time arrival of PDSCH data. Aspects presented herein provide real-time adaptability that provides more efficient resource utilization and operational performance.

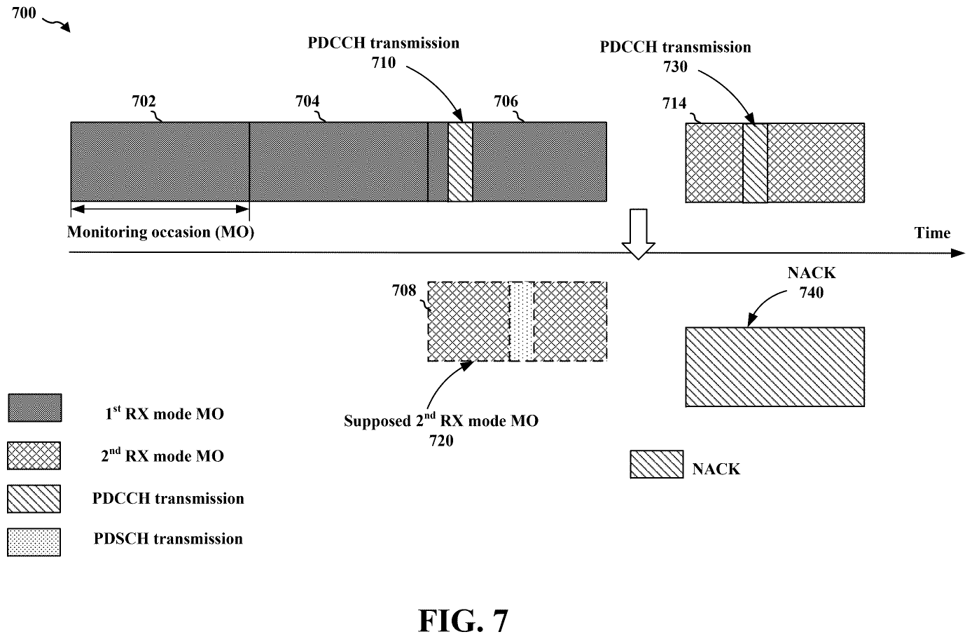

FIG. 7 is a diagram 700 illustrating a further example of a reception mode switching for monitoring downlink communication in which the UE is not able to receive a PDSCH. As shown, a UE (e.g., the UE 410 in FIG. 4) may switch between different reception modes based on pre-configured rules and network-defined events, such as receiving PDCCH transmissions.

The UE may initially operate in a low-power reception mode, utilizing a reduced number of antennas, such as a single antenna (e.g., 1 antenna 412, 1Rx), to monitor for PDCCH transmissions with control information (such as scheduling grants or DCI indicating upcoming data transmissions) during the RX mode monitoring occasions (MOs) 702, 704, and 706. This low-power mode may be designed to enhance energy efficiency during idle periods or while monitoring control signals, thereby minimizing power consumption. In some aspects, the UE may determine to reduce the number of Rx antennas used to monitor for downlink transmissions, e.g., use of the first Rx mode, and the network may not be aware that the UE is using a reduced number of Rx antennas. In such aspects, the network may schedule the PDSCH without taking into account the time for the UE to change to a different reception mode.

Upon receiving a PDCCH transmission 710, the UE attempts to transition to a higher-capacity reception mode (e.g., with an increased number of Rx antennas such as 4Rx or 8Rx) to receive a PDSCH transmission during monitoring occasion(s) 708 using the second Rx mode. However, as illustrated by the dashed block 720, the timing for the switch to the higher-capacity mode may not align with the arrival of the PDSCH data. This misalignment can result in decoding failures, as the UE may not be fully prepared to process the data. In such cases, the UE may transmit a NACK 740, indicating its failure to decode the PDSCH data, which may trigger retransmission requests, thereby increasing resource usage and latency.

Following the data reception phase, the UE may switch to monitoring the PDCCH transmission 730 in one or more MOs 714 using the higher-capacity reception mode (e.g., the 4Rx or 8RX configuration) with a higher power consumption. In this example, the UE may monitor for the PDCCH and/or PDSCH in a BWP associated with a maximum rank of 4.

Aspects presented herein provide added power saving, greater efficiency, and more real-time adaptability than the examples with static or semi-dynamic, pre-configured transitions between reception modes, as described in connection with diagrams 500, 600, and 700. Aspects presented herein help to avoid unnecessary power consumption when the UE operates in higher-capacity modes (e.g., 4Rx/6Rx/8Rx) without missed opportunities to decode data accurately due to reception mode transitions that are not aligned with actual network conditions. Aspects reduce latency and improve the accuracy of downlink reception by the UE. The approaches presented herein provide a balance between performance and energy efficiency. To provide such improved efficiencies, dynamic, event-based reception mode switching mechanisms offer a more effective solution. By optimizing timing based on real-time network indications, such mechanisms enable the UE to transition between modes in accordance with the network indications, thereby achieving improved power efficiency and enhanced data decoding performance.

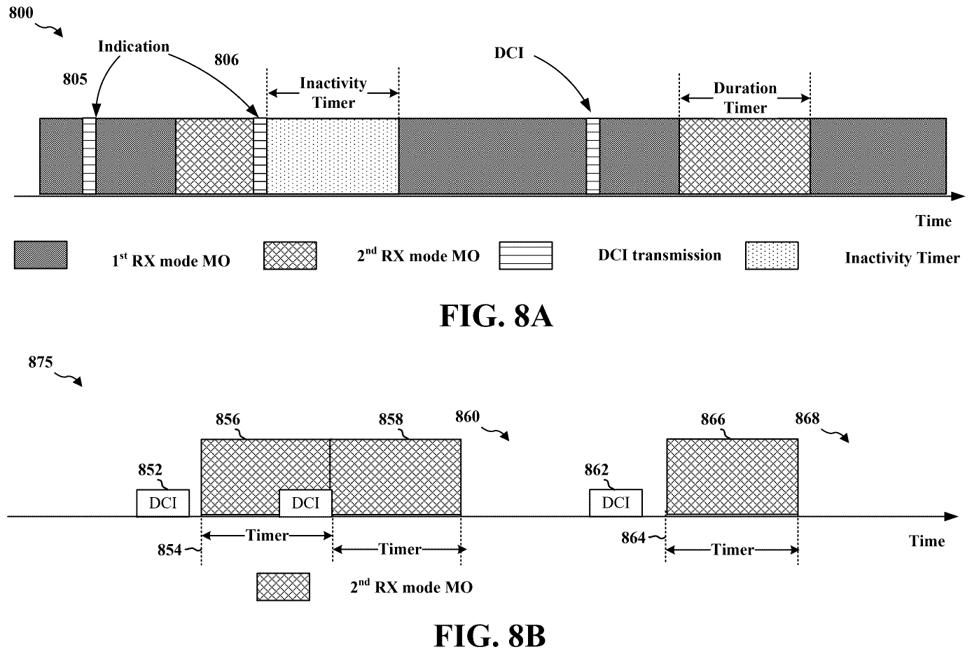

FIG. 8A and FIG. 8B are diagrams 800 and 875 illustrating examples of a dynamic reception mode switching for monitoring downlink communication, in accordance with various aspects of the present disclosure. In some aspects, the trigger for the switch may be referred to as event based Rx mode switch triggering. As shown in diagram 800 and 875, the UE (e.g., the UE 410 in FIG. 4) may begin in a first reception mode (e.g., using a reduced number of active Rx antennas, such as 1Rx or 2Rx) to monitor for downlink communications. As stated above, the lower-power/lower-capacity reception mode may be designed to conserve energy during idle periods or while monitoring control information.

In some aspects, the UE may switch to the higher-capacity Rx mode based on detection of a PDCCH transmission. In some aspects, the UE may switch to the higher-capacity Rx mode based on detection of a downlink grant. In some aspects, the UE may switch to the higher-capacity Rx mode based on a switching indication comprised in the PDCCH transmission (e.g., DCI). For example, FIG. 8B illustrates that a UE may receive DCI 852 (e.g., a PDCCH transmission or a DL or UL grant). In response, the UE switches, e.g., at 854, to the second RX mode for a duration of time 856.

In some aspects, upon receiving an indication 805 (e.g., via a downlink grant and/or DCI indicated in one or more PDCCH transmissions, demodulation reference signals (DMRS), or indications corresponding to one or more conditions configured for the UE to trigger a switch from the first reception mode to the second reception mode), the UE may transition to a second reception mode (e.g., 4Rx, 6Rx, or 8Rx) for monitoring the downlink communication utilizing more antennas to enhance downlink communication performance.

In some aspects, the one or more conditions configured for the UE to trigger a switch from the first reception mode to the second reception mode may correspond to one or more of a SNR measurement of the downlink communication that meets an SNR threshold, a RSRP measurement that meets an RSRP threshold, or an indication for a search space having an AL associated with the second reception mode.

For example, the indication may correspond to a threshold for SNR measurements taken during the monitoring for the PDCCH transmission. For instance, if the measured SNR exceeds the threshold configured in the indication, it may indicate for the UE to transition to the higher-capacity reception mode (e.g., the second reception mode).

The indication may also correspond to a threshold for RSRP measurements, which may correspond to power level measurements of reference signals such as DMRS or other pilot signals embedded in PDSCH. When the measured RSRP exceeds this threshold, it may indicate the need for additional reception capability to ensure reliable data decoding.

Additionally or alternatively, the indication may correspond to a search space indication with a specific or particular aggregation level. The aggregation level may correspond to the number of contiguous control channel elements (CCEs) used to transmit a control message, such as DCI, in the PDCCH. The aggregation level may correspond to the robustness required for DCI decoding under varying channel conditions. For instance, lower aggregation level (AL) values, such as AL=1, may indicate higher-quality channels where fewer CCEs are sufficient to reliably transmit control information. These conditions may be suitable for UEs operating in higher-capacity reception modes, such as 4Rx or 8Rx, where additional antennas can be utilized for efficient data decoding. Higher aggregation level values, such as AL=8, may indicate weaker channel conditions that require greater redundancy to ensure successful decoding. Under such conditions, UEs may operate in lower-power reception modes, such as 1Rx or 2Rx, prioritizing energy efficiency while maintaining adequate performance for control monitoring. For example, if the aggregation level associated with a PDCCH transmission corresponds to conditions requiring robust decoding—such as those indicated by lower aggregation level values—the UE may transition to a second reception mode with more antennas (e.g., 4Rx, 6Rx, or 8Rx) to improve performance. Alternatively, in cases of higher aggregation level values, the UE may remain in or switch back to the first reception mode (e.g., 1Rx or 2Rx) to conserve power.

In some aspects, the indication 805 may be indicated in DCI which may include a switching indication that configures the UE to transition between reception modes (e.g., from the lower-capacity reception mode to the higher-capacity reception mode, or vice versa). As an example, the DCI may indicate the transition to the different reception mode without indicating a BWP switch. For instance, the switching indication may be indicated within the “antenna ports” field of the DCI. Additionally, the indication 805 may be configured in accordance with an NR PDSCH DMRS configuration. For example, the NR PDSCH DMRS configuration may convey information regarding the number of antennas required for effective data decoding. For example, the NR DCI format 1_1 may include an “antenna ports” field, which can indicate the antenna configuration necessary for the UE to transition between reception modes.

In some aspects, to enhance flexibility and adaptability, e.g., in future-generation networks, the DCI configuration may be extended to include additional fields. For example, 1 or 2 additional bits may be introduced in a fallback DCI format to trigger the transition from (or between) the first reception mode and the second reception mode.

Upon meeting the triggering conditions, the UE may initiate the reception mode switch in accordance with the received indication, enabling the UE to adapt to the improved channel conditions for enhanced communication performance.

In some aspects, unlike the reception mode switching shown in diagram 600, the dynamic reception mode switching discussed herein (e.g., as shown in diagram 800) may be independent of switching the BWP. For example, the indication 805 may correspond to adapting the second reception mode while remaining within the existing BWP configuration. In this context, both the first reception mode (e.g., 1Rx or 2Rx) and the second reception mode (e.g., 4Rx, 6Rx, or 8Rx) may operate within the same BWP. As such, the mode adaptation may be performed independently of any frequency or bandwidth adjustments associated with BWP switching. This approach enables seamless and efficient adaptation of the UE's reception mode without incurring the additional complexity or delay associated with BWP transitions.

If PDCCH activity is detected, it may be more likely that additional downlink transmissions will be scheduled for the UE. If the UE transitions back to the lower-capacity Rx mode, the UE may miss (or reduce its ability to receive) later scheduling grants, assignments, or other downlink transmissions. In some aspects, the timing for switching from the first reception mode to the second reception mode, as indicated by the indication 805, may be based on a duration timer. The duration timer corresponds to the period during which the UE remains in the second reception mode following a Rx mode switching trigger (e.g., such as PDCCH detection, downlink grant detection, DCI detection, measurement trigger, and/or Rx mode switch indication). The timer duration may be a configurable parameter (e.g., a parameter that is configured for the UE by the network). In some aspects, the timer duration may be defined, e.g., defined in a wireless standard. In some aspects, the UE may determine the timer duration, e.g., as an autonomously selected parameter rather than receiving a configuration or using a defined timer. In some aspects, the timer duration may be indicated in the indication 805. For instance, upon switching to the second reception mode (e.g., 4Rx/6Rx/8Rx), the UE may remain in this higher-capacity reception mode for the duration indicated for the timer (e.g., until the timer expires), which helps to improve reliable decoding of upcoming downlink transmissions such as PDSCH. If the duration timer expires without additional PDCCH activity (e.g., without the UE detecting a PDCCH transmission, resource grant (e.g., for DL or UL), or DCI) or further indications, the UE transitions back to the first reception mode (e.g., 1Rx or 2Rx), thereby resuming its power-efficient operation.

FIG. 8B illustrates an example in which the UE remains in the second RX mode for the duration of time 856 based on reception of the DCI 852. As the UE receives a DCI during time 856, the UE continues in the second RX mode for during 858 (e.g. and restarts the timer). In FIG. 8B, the UE does not receive a DCI during 858, and transitions to the first RX mode during 860. In response to receiving the DCI 862, the UE transitions, at 864, to the second RX mode for a duration of time 866. As the time expires without reception of DCI, the UE transitions back to the first RX mode as shown at 868.

In some aspects, the indication 805 may also include (or trigger use of) a switch inactivity timer. This timer corresponds to the time the UE remains in the second reception mode before switching back to the first reception mode, when further control information (e.g., additional PDCCH activity or indications such as another indication 806) is received during the second reception mode. For example, if the UE receives additional control information while in the second reception mode, the switch inactivity timer begins counting a predefined number of subframes. Each time new control information is received while the timer is active, the timer resets, extending the UE's time in the second reception mode. However, if the switch inactivity timer expires without further control information, the UE switches back to the first reception mode to conserve power.

Additionally or alternatively, the indication 805 may include a start offset timer, which corresponds to a delay or offset before the UE transitions to the second reception mode upon receiving the indication 805. For example, the indication 805 may correspond to a timing offset between a DCI grant and the corresponding PDSCH transmission for switching from the first reception mode to the second reception mode, such that during the offset, the UE does not receive downlink transmissions. The start offset timer may be configured based on the UE's minimal reaction time required to switch from the first reception mode to the second reception mode.

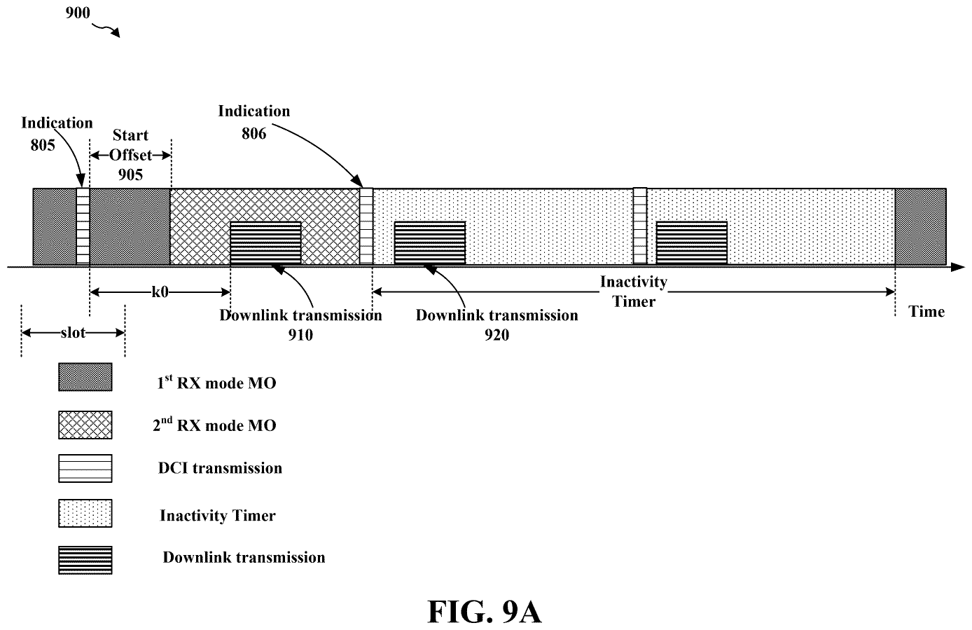

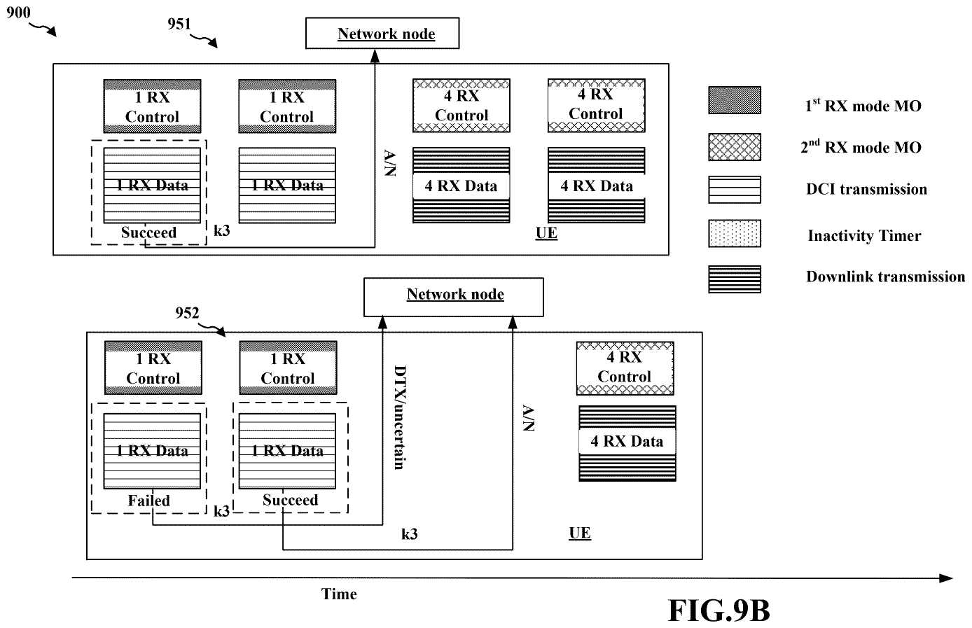

In some aspects, an offset, e.g., k0, may correspond to the time interval between DCI grant scheduling a downlink transmission (e.g., the indication 805) and a corresponding PDSCH transmission, downlink transmission 910 (e.g., the first grant in the data burst for the communication data), as shown in FIG. 9A. In some aspects, to provide the UE with sufficient reaction time to switch from the first RX mode to the second RX mode, k0 may be no shorter than the start offset timer 905 (e.g., k0≥start offset timer 905). As an example, k0 may be greater than zero (e.g., with the scheduled data transmission in at least a next slot) to allow time for the UE to change reception modes. For example, as illustrated in FIG. 9A, the UE receives the indication 805 (e.g., DCI grant that schedules PDSCH transmission (e.g., 910)), having an offset k0 so that the transition to the second reception mode is completed in time to decode the corresponding downlink transmission 910.

In scenarios where a subsequent indication (e.g., indication 806 such as DCI scheduling a downlink or uplink transmission such as PDSCH or PUSCH) is received during the time that the UE monitors using second reception mode (e.g., while the duration timer or the switch inactivity timer is still active), k0 may be shorter than the start offset timer 905. Under such conditions, the corresponding downlink transmission 920 may immediately follow the indication 806 (e.g., in the next slot), as the UE is already in the second reception mode and thus prepared for efficient data decoding without needing additional transition time. In some aspects, the UE may indicate to the network that the UE will, or may, use a reception mode with a reduced number of receive antennas so that the network knows to use a k0>0 at the start of a data burst. In some aspects, without the UE indicating use of a particular reception mode, the network may indicate to the UE that the network will use a timing (k0>0 for a first data burst) that allows the UE to use the reception mode with a reduced number of receive antennas and to transition to the second reception mode in time to receive the PDSCH transmission.

By appropriately configuring the start offset timer and k0 to account for the UE's transition time, the system ensures reliable and timely transitions between reception modes.

While the second reception mode is generally described herein as a higher-capacity reception mode (e.g., 4Rx/6Rx/8Rx) and the first reception mode as a lower-capacity reception mode (e.g., 1Rx or 2Rx), the disclosed system is equally applicable in reverse. For example, the UE may transition from a higher-capacity reception mode to a lower-capacity reception mode to optimize power consumption during periods of reduced activity or minimal data requirements upon receiving an indication configured similarly to indication 805. For brevity, the details of this reverse operation are not repeated here, as they adhere to the same principles.

By configuring one or more timers (e.g., the duration timer, the switch inactivity timer, and/or the start offset timer) using the network indication (e.g., the indication 805), the disclosed system enables dynamic adaptation between different reception modes. This adaptability optimizes the UE's performance by balancing higher-capacity decoding during the higher-capacity reception mode (e.g., 4Rx/6Rx/8Rx) with energy efficiency during the lower-capacity reception mode (e.g., 1Rx or 2Rx). As a result, the system effectively tailors the UE's behavior to real-time network conditions, ensuring a balance between performance and power efficiency. Additionally or alternatively, in some aspects, the UE may provide feedback to the network node regarding the successful reception of the indication (e.g., the indication 805) for transitioning between reception modes. The feedback informs the network node about the UE's readiness for subsequent downlink communications. For example, FIG. 9B is a diagram 900 illustrating an example feedback timeline for reporting the reception of the indication, in accordance with various aspects of the present disclosure. In some aspects, upon receiving a valid indication (e.g., indication 805) indicating the switch to a different reception mode (e.g., a higher capacity reception mode such as 4Rx mode), the UE may transition in accordance with the indication. As shown in diagram 951, an acknowledgment (ACK/NACK) for the control information (e.g., indication 805) may be sent back to the network node with a delay of k3 representing the time between the indication slot (e.g., DCI or slot with DCI) and the physical uplink control channel (PUCCH) slot for ACK/NACK feedback.

If the control information (e.g., indication 805) decoding fails, as shown in diagram 952, the UE remains in its current reception mode (1Rx) and reports discontinuous transmission (DTX) or uncertainty in the feedback with a delay of k3. If at the next occasion, the reception of a valid the control information (e.g., indication 805) indicating the switch to the different reception mode (e.g., 4Rx mode) is successful, the UE may transition in accordance with the indication. Similar to what is shown in diagram 951, an acknowledgment (ACK/NACK) for the indication may be sent back to the network node with a delay of k3.

As shown in FIG. 9B, the switch to the second reception mode may be performed after an ACK from the UE.

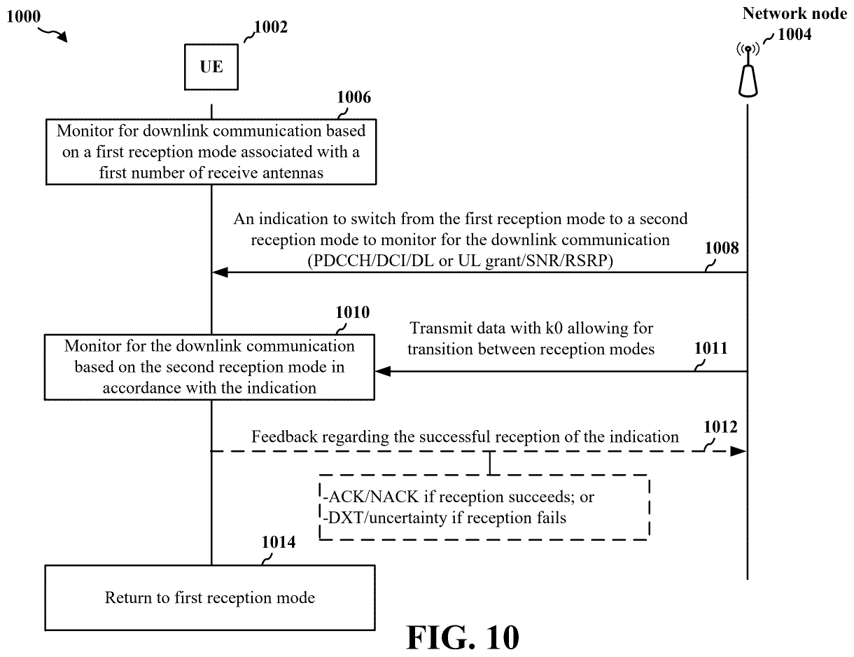

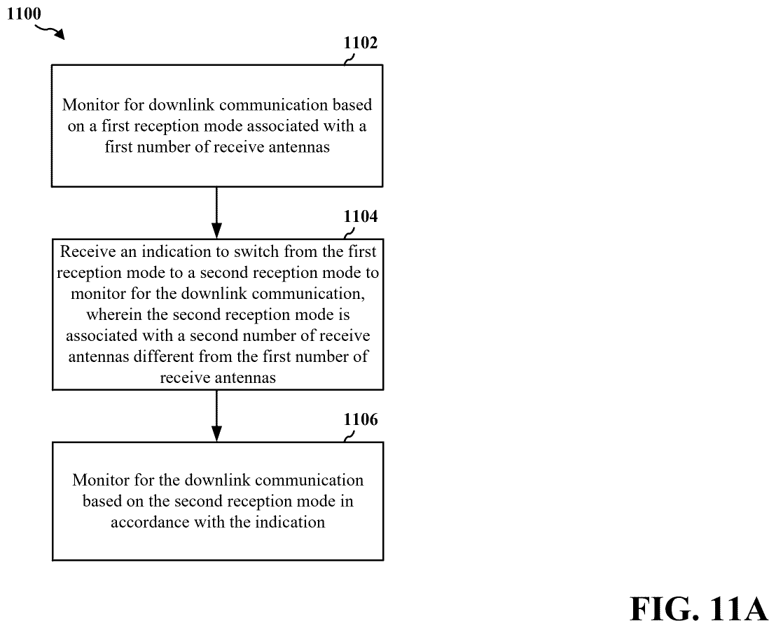

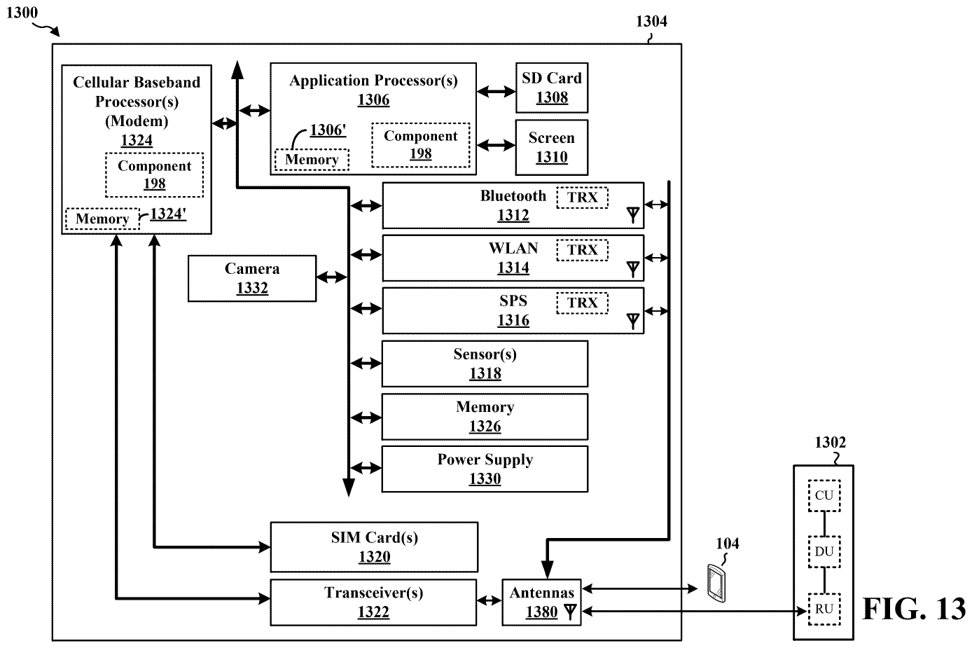

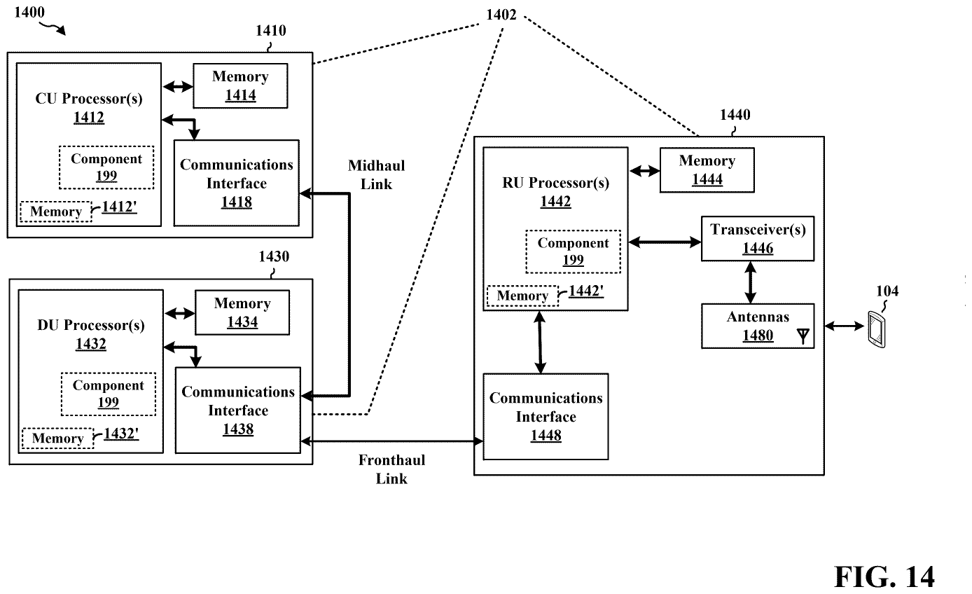

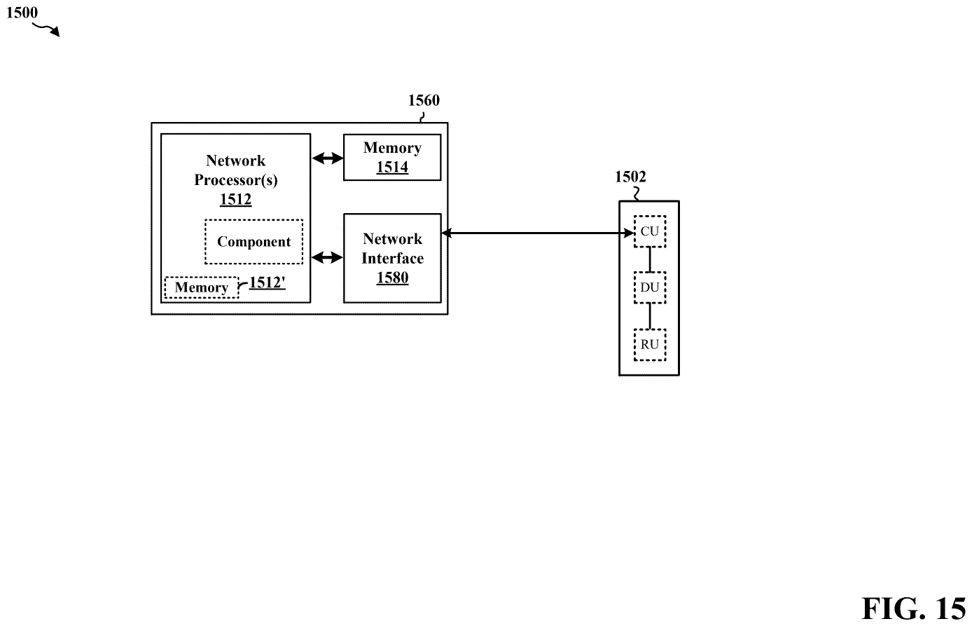

FIG. 10 is a call diagram 1000 illustrating an example of a dynamic reception mode switching for monitoring downlink communication, in accordance with various aspects of the present disclosure. The dynamic reception mode switching for monitoring downlink communication in the example call diagram 1000 may be performed between a UE 1002 and a network node 1004. In some aspects, the UE 1002 may correspond to the UE 104 in FIG. 1, the UE 350 in FIG. 3, the UE 410 in FIG. 4, or the apparatus 1304 in the hardware implementation of FIG. 13. The network node 1004 may correspond to the base station 102 in aggregation and/or by one or more components (e.g., such as a CU 110, a DU 130, and/or an RU 140) in FIG. 1, the base station 310 in aggregation and/or by one or more components in FIG. 3, or the network entity 1402 in the hardware implementation of FIG. 14. In some aspects, the network node 1004 may also correspond to a network entity in the core network 120 in FIG. 1 or the apparatus (e.g., 1560) in the hardware implementation of FIG. 15. The communication may include any of the aspects described in connection with FIGS. 5-9B.

At 1006, the UE 1002 may monitor for downlink communication in a first reception mode (e.g., 1Rx or 2Rx), which utilizes fewer active receive antennas. As described earlier, this lower-capacity reception mode may be designed to conserve power during idle periods or while monitoring for control information, thereby optimizing energy efficiency in scenarios with reduced downlink communication activity or control monitoring.

At 1008, the network node 1004 may transmit to the UE 1002 an indication (e.g., the indication 805 as shown in FIGS. 8A, 8B, 9A, and 9B) configuring the UE 1002 to switch from the first reception mode to a second reception mode (e.g., 4Rx, 6Rx, or 8Rx) for monitoring communication data (e.g., PDSCH transmissions). This second reception mode leverages more antennas to improve downlink communication performance and may be referred to as a higher-capacity reception mode in some aspects. The indication may correspond to various triggers, such as a PDCCH transmission, DCI, a downlink grant and/or an UL grant, DMRS, and/or indications tied to one or more conditions for the UE. Such conditions could include SNR thresholds, RSRP levels, and/or search space indications associated with particular ALs.

At 1010, upon receiving the indication, the UE 1002 may transition to the second reception mode (e.g., 4Rx, 6Rx, or 8Rx) for monitoring downlink communication. As stated above, the transition enables the UE to utilize additional antennas, enhancing its ability to monitor and decode downlink communications effectively, particularly for data-intensive transmissions such as data carried on the PDSCH.

As illustrated at 1011, the network node 1004 may transmit data (e.g., PDSCH) transmissions to the UE 1002 using a k0>0 in a first transmission to allow for the UE to transition between reception modes, e.g., as described in connection with FIG. 9A.

In some aspects, at 1012, the UE may optionally provide feedback to the network node regarding the successful reception of the indication (e.g., the indication 805) for transitioning between reception modes, as illustrated in FIG. 9B.

It is noted that the technical details associated with 1006 and 1010, and 1008 and 1012, may include any of the aspects discussed with respect to FIGS. 4-9B and are not repeated here for brevity.

As shown at 1014, the UE may transition back to using the first reception mode. The transition may be based on expiration of a timer, such as described in connection with FIGS. 8A and 8B, for example.

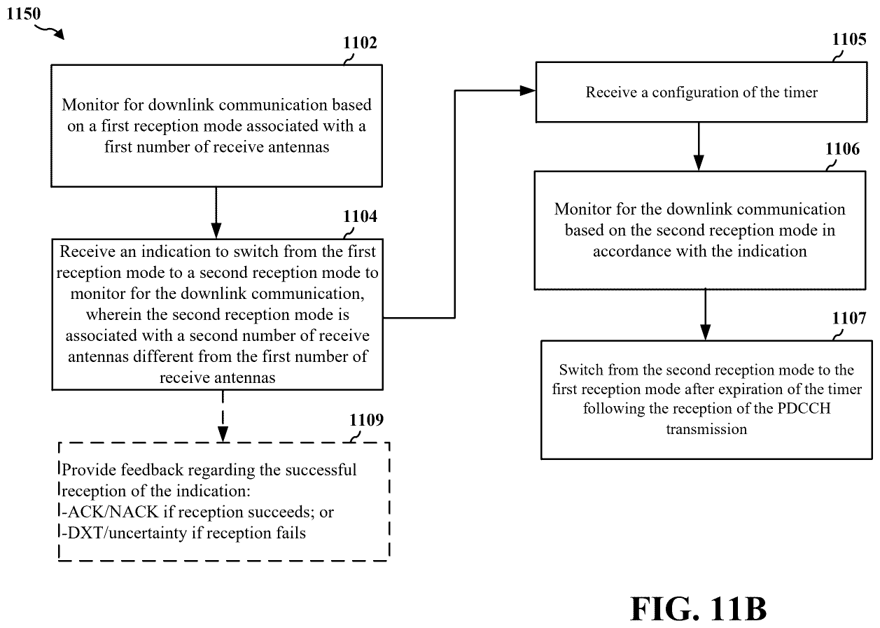

FIG. 11A is a flowchart 1100 of a method of wireless communication at a UE, in accordance with various aspects of the present disclosure. The UE may correspond to the UE 104 in FIG. 1, the UE 350 in FIG. 3, the UE 410 in FIG. 4, the UE 1002 in FIG. 10, or the apparatus 1304 in the hardware implementation of FIG. 13. The method provides for power savings at the UE by enabling the UE to use a reception mode with fewer active receive antennas, at times, while providing for accurate reception of communication with a network node with consideration of a change of reception modes at the UE.

As stated above, the UE may include plurality of receive antennas (e.g., 4, 6, or 8 antennas 412) coupled to a radio (e.g., the radio 414) for performing RF functions. In some aspects, the radio, also referred to as the main radio, may be configured to receive control information (e.g., PDCCH transmissions) and/or data transmissions (e.g., PDSCH transmissions) under different reception modes. For example, the radio may monitor downlink transmissions in a first mode using a smaller number of antennas (e.g., 1 or 2 antennas) or in a second mode using a greater number of antennas (e.g., 4, 6, or 8 antennas). In some aspects, the first mode may be configured to monitor control signals (e.g., PDCCH transmissions), and while operating in the first mode, the UE may function in an idle mode to conserve power. The second mode may be configured to monitor user data transmissions (e.g., PDSCH transmissions), with the UE functioning in an active mode to enable improved decoding of communication data (e.g., video, web content, etc.). The switching of reception modes allows the UE to balance power efficiency during control monitoring and enhanced performance during data reception.

Starting at 1102, the UE may monitor for downlink communication based on the first reception mode associated with a first number of receive antennas. In some aspects, the UE may monitor for downlink communication in the first reception mode for downlink communication as discussed with respect to FIGS. 8A, 8B, 9A, and 9B. In some aspects, 1102 may be performed by the RX mode switching component 198.

At 1104, the UE may receive an indication (e.g., indication 805 in FIG. 8A, 8B, 9A or 9B) to switch from the first reception mode to a second reception mode to monitor for the downlink communication, wherein the second reception mode is associated with a second number of receive antennas different from the first number of receive antennas. For example, the indication 805 may correspond to a timing offset between a DCI grant and the corresponding PDSCH transmission for switching from the first reception mode to the second reception mode, such that during the offset, the UE does not receive downlink transmissions. In some aspects, 1104 may be performed by the RX mode switching component 198.

As stated above, the indication may correspond to a downlink grant and/or DCI indicated in one or more PDCCH transmissions, DMRS, or one or more conditions configured for the UE to trigger a switch from the first reception mode to the second reception mode.

In some aspects, the one or more conditions configured for the UE to trigger a switch from the first reception mode to the second reception mode may correspond to one or more of a SNR measurement of the downlink communication that meets an SNR threshold, a RSRP measurement that meets an RSRP threshold, or an indication for a search space having an AL associated with the second reception mode.

For example, the indication may correspond to a threshold for SNR measurements taken during the monitoring for the PDCCH transmission. For instance, if the measured SNR exceeds the threshold configured in the indication, it may indicate that the channel quality is adequate to support a transition to the high-capacity reception mode (e.g., the second reception mode).

The indication may also correspond to a threshold for RSRP measurements, which may correspond to power level measurements of reference signals such as DMRS or other pilot signals embedded in PDSCH. When the measured RSRP exceeds this threshold, it may indicate the need for additional reception capability to ensure reliable data decoding.

Additionally or alternatively, the indication may correspond to a search space indication with a specific or particular AL. For example, if the AL associated with a PDCCH transmission corresponds to conditions requiring robust decoding—such as those indicated by low AL values—the UE may transition to a second reception mode with more antennas (e.g., 4Rx, 6Rx, or 8Rx) to improve performance. Alternatively, in cases of high AL values the UE may remain in or switch back to the first reception mode (e.g., 1Rx or 2Rx) to conserve power.

Upon meeting the triggering conditions, the UE may initiate the reception mode switch in accordance with the received indication, enabling the UE to adapt to the improved channel conditions for enhanced communication performance.

In some aspects, unlike the reception mode switching shown in diagram 600, the dynamic reception mode switching discussed herein (e.g., as shown in flowchart 1100) does not involve switching the BWP. For example, the indication disclosed herein may correspond to adapting the second reception mode while remaining within the existing BWP configuration. In this context, both the first reception mode (e.g., 1Rx or 2Rx) and the second reception mode (e.g., 4Rx, 6Rx, or 8Rx) may operate within the same BWP. As such, the mode adaptation may be performed independently of any frequency or bandwidth adjustments associated with BWP switching. This approach enables seamless and efficient adaptation of the UE's reception mode without incurring the additional complexity or delay associated with BWP transitions.

In some aspects, the timing for switching from the first reception mode to the second reception mode, as indicated by the indication, may involve multiple configurable timers, such as a duration timer, a switch inactivity timer, and/or a start offset timer.

The duration timer may specify the period during which the UE remains in the second reception mode. The duration timer may be a configurable parameter included in the indication. The switch inactivity timer may correspond to the time the UE remains in the second reception mode before switching back to the first reception mode, when further control information (e.g., additional PDCCH activity or indications such as another indication 806) is received during the second reception mode. The start offset timer may correspond to a delay or offset before the UE transitions to the second reception mode upon receiving the indication. In some aspects, the start offset timer may be configured based on the UE's minimal reaction time required to switch from the first reception mode to the second reception mode.

In some aspects, a offset k0 may correspond to the time interval between the indication and a corresponding downlink transmission (e.g., downlink transmission 910 in FIG. 9A). To ensure the UE with sufficient reaction time to switch from the first reception mode to the second reception mode, k0 may be no shorter than the start offset timer (e.g., k0≥start offset).

In scenarios where a subsequent indication (e.g., indication 806 in FIG. 9A) is received during the second reception mode (e.g., while the duration timer or the switch inactivity timer is still active), the requirement for k0 to be no shorter than the start offset timer may no longer apply. Under such conditions, the corresponding downlink transmission (e.g., the downlink transmission 920 in FIG. 9A) may immediately follow the indication (e.g., the indication 806) in the next slot, as the UE is already in the second reception mode and thus prepared for efficient data decoding without needing additional transition time.

By appropriately configuring the start offset timer and k0 to account for the UE's minimal reaction time, the system ensures reliable and timely transitions between reception modes. This capability allows the UE to dynamically adapt to real-time network conditions, enabling effective preparation for decoding data transmissions while conserving power during control monitoring.

At 1106, the UE may monitor for the downlink communication based on the second reception mode in accordance with the indication. In some aspects, 1106 may be performed by the RX mode switching component 198.

FIG. 11B is a flowchart 1150 of a method of wireless communication at a UE, in accordance with various aspects of the present disclosure. The UE may correspond to the UE 104 in FIG. 1, the UE 350 in FIG. 3, the UE 410 in FIG. 4, the UE 1002 in FIG. 10, or the apparatus 1304 in the hardware implementation of FIG. 13. Some aspects of FIG. 11B may be similar to the aspects of FIG. 11A and are shown with the same reference number. The method provides for power savings at the UE by enabling the UE to use a reception mode with fewer active receive antennas, at times, while providing for accurate reception of communication with a network node with consideration of a change of reception modes at the UE.

As stated above, the UE may include plurality of receive antennas (e.g., 4, 6, or 8 antennas 412) coupled to a radio (e.g., the radio 414 for performing RF functions. In some aspects, the radio, also referred to as the main radio, may be configured to receive control information (e.g., PDCCH transmissions) and/or data transmissions (e.g., PDSCH transmissions) under different reception modes. For example, the radio may monitor downlink transmissions in a first mode using a smaller number of antennas (e.g., 1 or 2 antennas) or in a second mode using a greater number of antennas (e.g., 4, 6, or 8 antennas). In some aspects, the first mode may be configured to monitor control signals (e.g., PDCCH transmissions), and while operating in the first mode, the UE may function in an idle mode to conserve power. The second mode may be configured to monitor user data transmissions (e.g., PDSCH transmissions), with the UE functioning in an active mode to enable improved decoding of communication data (e.g., video, web content, etc.). The switching of reception modes allows the UE to balance power efficiency during control monitoring and enhanced performance during data reception.

Starting at 1102, the UE may monitor for downlink communication based on the first reception mode associated with a first number of receive antennas. In some aspects, the UE may monitor for downlink communication in the first reception mode for downlink communication as discussed with respect to FIGS. 8A, 8B, 9A, and 9B. In some aspects, 1102 may be performed by the RX mode switching component 198.

At 1104, the UE may receive an indication (e.g., indication 805 in FIG. 8A, 8B, 9A, or 9B) to switch from the first reception mode to a second reception mode to monitor for the downlink communication, wherein the second reception mode is associated with a second number of receive antennas different from the first number of receive antennas. In some aspects, 1104 may be performed by the RX mode switching component 198.

As stated above, the indication may correspond to a downlink grant and/or DCI indicated in one or more PDCCH transmissions, DMRS, or one or more conditions configured for the UE to trigger a switch from the first reception mode to the second reception mode.

In some aspects, the one or more conditions configured for the UE to trigger a switch from the first reception mode to the second reception mode may correspond to one or more of a SNR measurement of the downlink communication that meets an SNR threshold, a RSRP measurement that meets an RSRP threshold, or an indication for a search space having an AL associated with the second reception mode.

For example, the indication may correspond to a threshold for SNR measurements taken during the monitoring for the PDCCH transmission. For instance, if the measured SNR exceeds the threshold configured in the indication, it may indicate that the channel quality is adequate to support a transition to the high-capacity reception mode (e.g., the second reception mode).

The indication may also correspond to a threshold for RSRP measurements, which may correspond to power level measurements of reference signals such as DMRS or other pilot signals embedded in PDSCH. When the measured RSRP exceeds this threshold, it may indicate the need for additional reception capability to ensure reliable data decoding.

Additionally or alternatively, the indication may correspond to a search space indication with a specific AL. For example, if the AL associated with a PDCCH transmission corresponds to conditions requiring robust decoding—such as those indicated by low AL values—the UE may transition to a second reception mode with more antennas (e.g., 4Rx, 6Rx, or 8Rx) to improve performance. Alternatively, in cases of high AL values, the UE may remain in or switch back to the first reception mode (e.g., 1Rx or 2Rx) to conserve power.

Upon meeting the triggering conditions, the UE may initiate the reception mode switch in accordance with the received indication, enabling the UE to adapt to the improved channel conditions for enhanced communication performance.

In some aspects, unlike the reception mode switching shown in diagram 600, the dynamic reception mode switching discussed herein (e.g., as shown in flowchart 1150) does not involve switching the BWP. For example, the indication disclosed herein may correspond to adapting the second reception mode while remaining within the existing BWP configuration. In this context, both the first reception mode (e.g., 1Rx or 2Rx) and the second reception mode (e.g., 4Rx, 6Rx, or 8Rx) may operate within the same BWP. As such, the mode adaptation may be performed independently of any frequency or bandwidth adjustments associated with BWP switching. This approach enables seamless and efficient adaptation of the UE's reception mode without incurring the additional complexity or delay associated with BWP transitions.

In some aspects, the timing for switching from the first reception mode to the second reception mode, as indicated by the indication, may involve multiple configurable timers, such as a duration timer, a switch inactivity timer, and/or a start offset timer.

The duration timer may specify the period during which the UE remains in the second reception mode. The duration timer may be a configurable parameter included in the indication. The switch inactivity timer may correspond to the time the UE remains in the second reception mode before switching back to the first reception mode, when further control information (e.g., additional PDCCH activity or indications such as another indication 806) is received during the second reception mode. The start offset timer may correspond to a delay or offset before the UE transitions to the second reception mode upon receiving the indication. In some aspects, the start offset timer may be configured based on the UE's minimal reaction time required to switch from the first reception mode to the second reception mode.

In some aspects, the indication 805 may correspond to a timing offset between a DCI grant and the corresponding PDSCH transmission for switching from the first reception mode to the second reception mode, such that during the offset, the UE does not receive downlink transmissions. In some aspects, a offset k0 may correspond to the time interval between the indication and a corresponding downlink transmission (e.g., downlink transmission 910 in FIG. 9A). To ensure the UE with sufficient reaction time to switch from the first reception mode to the second reception mode, k0 may be no shorter than the start offset timer (e.g., k0≥start offset).

In scenarios where a subsequent indication (e.g., indication 806 in FIG. 9A) is received during the second reception mode (e.g., while the duration timer or the switch inactivity timer is still active), the requirement for k0 to be no shorter than the start offset timer may no longer apply. Under such conditions, the corresponding downlink transmission (e.g., the downlink transmission 920 in FIG. 9A) may immediately follow the indication (e.g., the indication 806) in the next slot, as the UE is already in the second reception mode and thus prepared for efficient data decoding without needing additional transition time.

By appropriately configuring the start offset timer and k0 to account for the UE's minimal reaction time, the system ensures reliable and timely transitions between reception modes. This capability allows the UE to dynamically adapt to real-time network conditions, enabling effective preparation for decoding data transmissions while conserving power during control monitoring.

At 1105, the UE may receive a configuration of the timer (e.g., the duration timer or the switch inactivity timer). In some aspects, the configuration of the timer may be indicated in the indication (e.g., the indication 805 in FIG. 8A, 8B, 9A, or 9B) as stated above.

At 1106, the UE may monitor for the downlink communication based on the second reception mode in accordance with the indication. In some aspects, 1106 may be performed by the RX mode switching component 198.

At 1107, the UE may switch from the second reception mode to the first reception mode after expiration of the timer following the reception of the PDCCH transmission (e.g., the indication 805 in FIG. 8A, 8B, 9A, or 9B). As state above, if the timer (e.g., (e.g., the duration timer or the switch inactivity timer) expires without further control information, the UE switches back to the first reception mode.

At 1109, the UE may optionally provide feedback regarding the successful reception of the indication (e.g., ACK/NACK if the reception succeeds, or DXT/uncertainty if the reception fails).

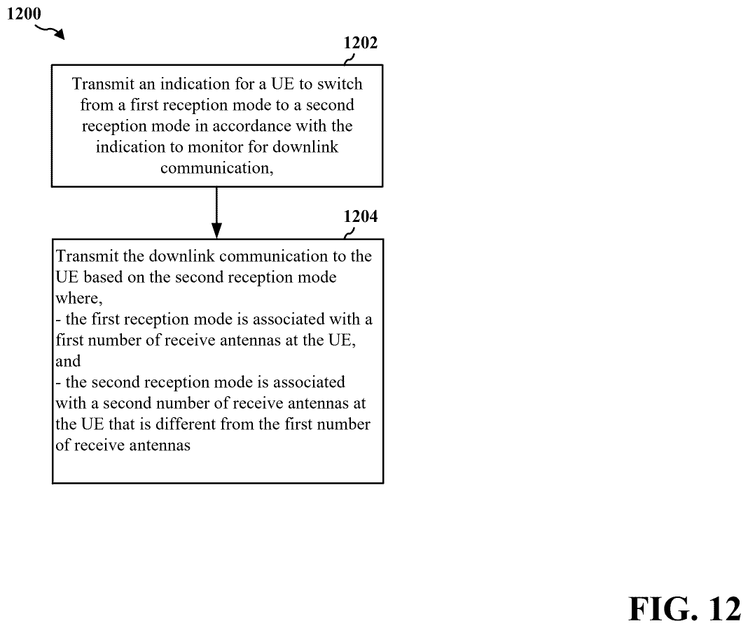

FIG. 12 is a flowchart 1200 of a method of wireless communication at a network node, in accordance with various aspects of the present disclosure. The network node may correspond to the base station 102 in aggregation and/or by one or more components (e.g., such as a CU 110, a DU 130, and/or an RU 140) in FIG. 1, the base station 310 in aggregation and/or by one or more components in FIG. 3, the network node 1004 in FIG. 10, or the network entity 1402 in the hardware implementation of FIG. 14. In some aspects, the network node may also correspond to a network entity in the core network 120 in FIG. 1, or the apparatus (e.g., 1560) in the hardware implementation of FIG. 15. The method helps to ensure accurate communication between a network node and a UE while also enabling power savings at the UE by allowing the UE to use a reception mode with fewer active receive antennas, at times.

At 1202, the network node may transmit an indication for a user equipment (UE) to switch from a first reception mode to a second reception mode in accordance with the indication to monitor for downlink communication. In some aspects, the first reception mode is associated with a first number of receive antennas at the UE, and the second reception mode is associated with a second number of receive antennas at the UE that is different from the first number of receive antennas. In some aspects, 1202 may be performed by the RX mode switching component 199.

In some aspects, the indication may include a PDCCH transmission that indicates to switch to the second reception mode following reception of the PDCCH transmission until a timer expires.

In some aspects, the indication may correspond to a downlink grant indicated in a PDCCH transmission.

In some aspects, the indication may include DCI included in a PDCCH transmission.

In some aspects, the DCI may include a switching indication that informs the UE to switch to the second reception mode.

In some aspects, the switching indication may be comprised in an antenna port field of the DCI.

In some aspects, the indication may be indicated based on a PDSCH DMRS configuration.

In some aspects, the indication corresponds to an occurrence of one or more conditions triggering the switch from the first reception mode to the second reception mode, wherein the one or more conditions are configured for the UE, corresponding to one or more of a SNR measurement of the downlink communication that meets an SNR threshold, a RSRP measurement that meets an RSRP threshold, or a search space indication for a search space having an AL associated with the second reception mode.

In some aspects, the second number of receive antennas is larger than the first number of receive antennas.

In some aspects, the indication is received at least an offset before a corresponding downlink transmission for reception with the second number of receive antennas.

In some aspects, the second number of receive antennas is smaller than the first number of receive antennas.

At 1204, the network node may the downlink communication to the UE based on the second reception mode. In some aspects, 1204 may be performed by the RX mode switching component 199.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The cellular baseband processor(s) 1324 and the application processor(s) 1306 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the RX mode switching component 198 may be configured to monitor for downlink communication based on a first reception mode associated with a first number of receive antennas, receive an indication to switch from the first reception mode to a second reception mode to monitor for the downlink communication, wherein the second reception mode is associated with a second number of receive antennas different from the first number of receive antennas, and monitor for the downlink communication based on the second reception mode in accordance with the indication. The RX mode switching component 198 and/or the apparatus may be further configured to perform any of the aspects described in connection with the flowchart in FIG. 11A or 11B, and/or performed by the UE in the communication flow in FIG. 10. The RX mode switching component 198 may be within the cellular baseband processor(s) 1324, the application processor(s) 1306, or both the cellular baseband processor(s) 1324 and the application processor(s) 1306. The RX mode switching component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for monitoring for downlink communication based on a first reception mode associated with a first number of receive antennas, means for receiving an indication to switch from the first reception mode to a second reception mode to monitor for the downlink communication, wherein the second reception mode is associated with a second number of receive antennas different from the first number of receive antennas, and means for monitoring for the downlink communication based on the second reception mode in accordance with the indication. The apparatus may further include means for performing any of the aspects described in connection with the flowchart in FIG. 11A or 11B, and/or performed by the UE in the communication flow in FIG. 10. The means may be the RX mode switching component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the RX mode switching component 199 may be configured to transmit an indication for a UE to switch from a first reception mode to a second reception mode in accordance with the indication to monitor for downlink communication, and transmit the downlink communication to the UE based on the second reception mode where, the first reception mode is associated with a first number of receive antennas at the UE, and the second reception mode is associated with a second number of receive antennas at the UE that is different from the first number of receive antennas. The RX mode switching component 199 and/or the apparatus may be further configured to perform any of the aspects described in connection with the flowchart in FIG. 12, and/or performed by the network node in the communication flow in FIG. 10. The RX mode switching component 199 may be within one or more processors of one or more of the CU 1410, DU 1430, and the RU 1440. The RX mode switching component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 may include means for transmitting an indication for a UE to switch from a first reception mode to a second reception mode in accordance with the indication to monitor for downlink communication, and means for transmitting the downlink communication to the UE based on the second reception mode where, the first reception mode is associated with a first number of receive antennas at the UE, and the second reception mode is associated with a second number of receive antennas at the UE that is different from the first number of receive antennas. The network entity 1402 may further include means for performing any of the aspects described in connection with the flowchart in FIG. 12, and/or performed by the network node in the communication flow in FIG. 10. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 15 is a diagram 1500 illustrating an example of a hardware implementation for a network entity 1560. In one example, the network entity 1560 may be within the core network 120. The network entity 1560 may include at least one network processor 1512. The network processor(s) 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The network processor(s) 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the RX mode switching component 199 may be configured to transmit an indication for a UE to switch from a first reception mode to a second reception mode in accordance with the indication to monitor for downlink communication, and transmit the downlink communication to the UE based on the second reception mode where, the first reception mode is associated with a first number of receive antennas at the UE, and the second reception mode is associated with a second number of receive antennas at the UE that is different from the first number of receive antennas. The RX mode switching component 199 and/or the apparatus may be further configured to perform any of the aspects described in connection with the flowchart in FIG. 12, and/or performed by the network node in the communication flow in FIG. 10. The RX mode switching component 199 may be within the network processor(s) 1512. The RX mode switching component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1560 may include a variety of components configured for various functions. In one configuration, the network entity 1560 may include means for transmitting an indication for a UE to switch from a first reception mode to a second reception mode in accordance with the indication to monitor for downlink communication, and means for transmitting the downlink communication to the UE based on the second reception mode where, the first reception mode is associated with a first number of receive antennas at the UE, and the second reception mode is associated with a second number of receive antennas at the UE that is different from the first number of receive antennas. The means may be the RX mode switching component 199 of the network entity 1560 configured to perform the functions recited by the means.

By leveraging dynamic switching mechanisms based on indications such as downlink grants, DCI instructions, meeting one or more configured conditions (e.g., SNR thresholds, reference signal received power (RSRP) thresholds, and/or aggregation levels), or transmissions configured in the PDSCH DMRS configurations, the technical solutions disclosed herein enable prompt and dynamic reception mode switching, providing flexible and efficient antenna usage tailored to real-time network conditions, thereby enhancing the overall robustness of the communication system.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising monitoring for downlink communication based on a first reception mode associated with a first number of receive antennas; receiving an indication to switch from the first reception mode to a second reception mode to monitor for the downlink communication, wherein the second reception mode is associated with a second number of receive antennas different from the first number of receive antennas; and monitoring for the downlink communication based on the second reception mode in accordance with the indication.

Aspect 2 is the method of aspect 1, wherein the indication comprises a physical downlink control channel (PDCCH) transmission that indicates to switch to the second reception mode following reception of the PDCCH transmission until a timer expires.

Aspect 3 is the method of any of aspects 1 and 2, further comprising: receiving a configuration of the timer; and switching from the second reception mode to the first reception mode after expiration of the timer following the reception of the PDCCH transmission.

Aspect 4 is the method of any of aspects 1 to 3, wherein the indication corresponds to a downlink grant indicated in a physical downlink control channel (PDCCH) transmission.

Aspect 5 is the method of any of aspects 1 to 3, wherein the indication comprises downlink control information (DCI) included in a physical downlink control channel (PDCCH) transmission.

Aspect 6 is the method of any of aspects 1 to 5, wherein the DCI includes a switching indication that informs the UE to switch to the second reception mode.

Aspect 7 is the method of any of aspects 1 to 6, wherein the switching indication is comprised in an antenna port field of the DCI.

Aspect 8 is the method of any of aspects 1 to 7, wherein the indication is indicated based on a physical downlink shared channel (PDSCH) demodulation reference signal (DMRS) configuration.

Aspect 9 is the method of any of aspects 1 to 3, wherein the indication corresponds to an occurrence of one or more conditions triggering the switch from the first reception mode to the second reception mode, wherein the one or more conditions are configured for the UE, corresponding to one or more of: a signal to noise ratio (SNR) measurement of the downlink communication that meets an SNR threshold; a reference signal received power (RSRP) measurement that meets an RSRP threshold; or a search space indication for a search space having an aggregation level (AL) associated with the second reception mode.

Aspect 10 is the method of any of aspects 1 to 9, wherein the second number of receive antennas is larger than the first number of receive antennas.

Aspect 11 is the method of any of aspects 1 to 10, wherein monitoring for the downlink communication based on the first reception mode includes monitoring for a physical downlink control channel (PDCCH) transmission with a smaller number of receive antennas, and wherein monitoring for the downlink communication based on the second reception mode comprises: monitoring for a physical downlink shared channel (PDSCH) transmission based on a larger number of receive antennas.

Aspect 12 is the method of any of aspects 1 to 11, the indication may correspond to a timing offset between a DCI grant and the corresponding PDSCH transmission for switching from the first reception mode to the second reception mode, such that during the offset, the UE does not receive downlink transmissions.

Aspect 13 is the method of any of aspects 1 to 9, wherein the second number of receive antennas is smaller than the first number of receive antennas.

Aspect 14 is the method of any of aspects 1 to 13 further comprising transmitting a message indicating acknowledgment or negative acknowledgment after a timing offset, responsive to successfully decoding the indication to switch from the first reception mode to the second reception mode to monitor for the downlink communication.

Aspect 15 is the method of any of aspects 1 to 14 further comprising transmitting a message reporting discontinuous transmission or uncertainty after a timing offset, responsive to unsuccessfully decoding the indication to switch from the first reception mode to the second reception mode to monitor for the downlink communication.

Aspect 16 is an apparatus for wireless communication at a UE, comprising: at least one memory; and at least one processor coupled to the at least one memory, the at least one processor is configured to perform the method of any of aspects 1 to 15.

Aspect 17 is an apparatus for wireless communication at a UE, comprising means for performing each step in the method of any of aspects 1 to 15.

Aspect 18 is the apparatus of any of aspects 1 to 15, further comprising a transceiver configured to receive or to transmit in association with the method of any of aspects 1 to 15.

Aspect 19 is a computer-readable medium storing computer executable code at a UE, the code when executed by at least one processor causes the at least one processor to perform the method of any of aspects 1 to 15.

Aspect 20 is a method of wireless communication at a network node, transmitting an indication for a user equipment (UE) to switch from a first reception mode to a second reception mode in accordance with the indication to monitor for downlink communication, wherein: the first reception mode is associated with a first number of receive antennas at the UE, and the second reception mode is associated with a second number of receive antennas at the UE that is different from the first number of receive antennas; and transmitting the downlink communication to the UE based on the second reception mode.

Aspect 21 is the method of aspect 20, wherein the indication comprises a physical downlink control channel (PDCCH) transmission that indicates to switch to the second reception mode following reception of the PDCCH transmission until a timer expires.

Aspect 22 is the method of any of aspects 20 and 21, wherein the indication comprises a physical downlink control channel (PDCCH) transmission that indicates to switch to the second reception mode following reception of the PDCCH transmission until a timer expires.

Aspect 23 is the method of any of aspects 20 to 21, wherein the indication corresponds to a downlink grant indicated in a physical downlink control channel (PDCCH) transmission.

Aspect 24 is the method of any of aspects 20 to 21, wherein the indication comprises downlink control information (DCI) included in a physical downlink control channel (PDCCH) transmission.

Aspect 25 is the method of any of aspects 20 to 24, wherein the DCI includes a switching indication that informs the UE to switch to the second reception mode.

Aspect 26 is the method of any of aspects 20 to 25, wherein the switching indication is comprised in an antenna port field of the DCI.

Aspect 27 is the method of any of aspects 20 to 26, wherein the indication is indicated based on a physical downlink shared channel (PDSCH) demodulation reference signal (DMRS) configuration.

Aspect 28 is the method of any of aspects 20 to 27, wherein the indication corresponds to an occurrence of one or more conditions triggering the switch from the first reception mode to the second reception mode, wherein the one or more conditions are configured for the UE, corresponding to one or more of: a signal to noise ratio (SNR) measurement of the downlink communication that meets an SNR threshold; a reference signal received power (RSRP) measurement that meets an RSRP threshold; or a search space indication for a search space having an aggregation level (AL) associated with the second reception mode.

Aspect 29 is the method of any of aspects 20 to 28, wherein the second number of receive antennas is larger than the first number of receive antennas.

Aspect 30 is the method of any of aspects 20 to 29, the indication may correspond to a timing offset between a DCI grant and the corresponding PDSCH transmission for switching from the first reception mode to the second reception mode, such that during the offset, the UE does not receive downlink transmissions.

Aspect 31 is the method of any of aspects 20 to 30, wherein the second number of receive antennas is smaller than the first number of receive antennas.

Aspect 32 is an apparatus for wireless communication at a network node, comprising: at least one memory; and at least one processor coupled to the at least one memory, the at least one processor is configured to perform the method of any of aspects 20 to 30.

Aspect 33 is an apparatus for wireless communication at a network node, comprising means for performing each step in the method of any of aspects 20 to 30.

Aspect 34 is the apparatus of any of aspects 20 to 30, further comprising a transceiver configured to receive or to transmit in association with the method of any of aspects 18 to 28.

Aspect 35 is a computer-readable medium storing computer executable code at a network node, the code when executed by at least one processor causes the at least one processor to perform the method of any of aspects 20 to 30.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
monitor for downlink communication based on a first reception mode associated with a first number of receive antennas;
receive an indication to switch from the first reception mode to a second reception mode to monitor for the downlink communication, wherein the second reception mode is associated with a second number of receive antennas different from the first number of receive antennas; and
monitor for the downlink communication based on the second reception mode in accordance with the indication.

2. The apparatus of claim 1, wherein the indication comprises a physical downlink control channel (PDCCH) transmission that indicates to switch to the second reception mode following reception of the PDCCH transmission until a timer expires.

3. The apparatus of claim 2, wherein the at least one processor is further configured to:
receive a configuration of the timer; and
switch from the second reception mode to the first reception mode after expiration of the timer following the reception of the PDCCH transmission.

4. The apparatus of claim 1, wherein the indication corresponds to a downlink grant indicated in a physical downlink control channel (PDCCH) transmission.

5. The apparatus of claim 1, wherein the indication comprises downlink control information (DCI) included in a physical downlink control channel (PDCCH) transmission.

6. The apparatus of claim 5, wherein the DCI includes a switching indication that informs the UE to switch to the second reception mode.

7. The apparatus of claim 6, wherein the switching indication is comprised in an antenna port field of the DCI.

8. The apparatus of claim 6, wherein the indication is configured in accordance with a physical downlink shared channel (PDSCH) demodulation reference signal (DMRS) configuration.

9. The apparatus of claim 1, wherein the indication corresponds to an occurrence of one or more conditions that trigger the switch from the first reception mode to the second reception mode, wherein the one or more conditions are configured for the UE, include one or more of:
a signal to noise ratio (SNR) measurement of the downlink communication that meets an SNR threshold;
a reference signal received power (RSRP) measurement that meets an RSRP threshold; or
a search space indication for a search space that has an aggregation level (AL) associated with the second reception mode.

10. The apparatus of claim 1, wherein the second number of receive antennas is larger than the first number of receive antennas.

11. The apparatus of claim 10, wherein to monitor for the downlink communication based on the first reception mode, the at least one processor is configured to monitor for a physical downlink control channel (PDCCH) transmission with a smaller number of receive antennas, and wherein to monitor for the downlink communication based on the second reception mode, the at least one processor is configured to:
monitor for a physical downlink shared channel (PDSCH) transmission based on a larger number of receive antennas.

12. The apparatus of claim 10, wherein the indication corresponds to a timing offset between a DCI grant and a corresponding PDSCH transmission for switching from the first reception mode to the second reception mode, wherein during the timing offset, the UE does not receive downlink transmissions.

13. The apparatus of claim 1, wherein the second number of receive antennas is smaller than the first number of receive antennas.

14. The apparatus of claim 1, the at least one processor is further configured to:
transmit a message indicating acknowledgment or negative acknowledgment after a timing offset, responsive to successfully decoding the indication to switch from the first reception mode to the second reception mode to monitor for the downlink communication.

15. The apparatus of claim 1, the at least one processor is further configured to:
transmit a message reporting discontinuous transmission or uncertainty after a timing offset, responsive to unsuccessfully decoding the indication to switch from the first reception mode to the second reception mode to monitor for the downlink communication.

16. An apparatus for wireless communication at a network node, comprising:
at least one memory; and
at least one processor coupled to the at least one memory and, based at least in part on information stored in the at least one memory, the at least one processor is configured to:
transmit an indication for a user equipment (UE) to switch from a first reception mode to a second reception mode in accordance with the indication to monitor for downlink communication, wherein:
the first reception mode is associated with a first number of receive antennas at the UE, and
the second reception mode is associated with a second number of receive antennas at the UE that is different from the first number of receive antennas; and
transmit the downlink communication to the UE based on the second reception mode.

17. The apparatus of claim 16, wherein the indication comprises a physical downlink control channel (PDCCH) transmission that indicates to switch to the second reception mode following reception of the PDCCH transmission until a timer expires.

18. The apparatus of claim 16, wherein the indication corresponds to a downlink grant indicated in a physical downlink control channel (PDCCH) transmission.

19. The apparatus of claim 16, wherein the indication comprises downlink control information (DCI) included in a physical downlink control channel (PDCCH) transmission.

20. The apparatus of claim 19, wherein the DCI includes a switching indication that informs the UE to switch to the second reception mode.

21. The apparatus of claim 20, wherein the switching indication is comprised in an antenna port field of the DCI.

22. The apparatus of claim 20, wherein the indication is indicated based on a physical downlink shared channel (PDSCH) demodulation reference signal (DMRS) configuration.

23. The apparatus of claim 16, wherein the indication corresponds to an occurrence of one or more conditions that trigger the switch from the first reception mode to the second reception mode, wherein the one or more conditions are configured for the UE, corresponding to one or more of:
a signal to noise ratio (SNR) measurement of the downlink communication that meets an SNR threshold;
a reference signal received power (RSRP) measurement that meets an RSRP threshold; or
a search space indication for a search space that has an aggregation level (AL) associated with the second reception mode.

24. The apparatus of claim 16, wherein the second number of receive antennas is larger than the first number of receive antennas.

25. The apparatus of claim 24, wherein the indication corresponds to a timing offset between a DCI grant and a corresponding PDSCH transmission for switching from the first reception mode to the second reception mode, wherein during the timing offset, the UE does not receive downlink transmissions.

26. The apparatus of claim 16, wherein the second number of receive antennas is smaller than the first number of receive antennas.

27. The apparatus of claim 16, the at least one processor is further configured to:
receive a message indicating acknowledgment or negative acknowledgment after a timing offset, responsive to the UE successfully decoding the indication to switch from the first reception mode to the second reception mode to monitor for the downlink communication.

28. The apparatus of claim 16, the at least one processor is further configured to:
receive a message reporting discontinuous transmission or uncertainty after a timing offset, responsive to the UE unsuccessfully decoding the indication to switch from the first reception mode to the second reception mode to monitor for the downlink communication.

29. A method of wireless communication for a user equipment (UE), comprising:
monitoring for downlink communication based on a first reception mode associated with a first number of receive antennas;
receiving an indication to switch from the first reception mode to a second reception mode to monitor for the downlink communication, wherein the second reception mode is associated with a second number of receive antennas different from the first number of receive antennas; and
monitoring for the downlink communication based on the second reception mode in accordance with the indication.

30. A method of wireless communication for a network node, comprising:
transmitting an indication for a user equipment (UE) to switch from a first reception mode to a second reception mode in accordance with the indication to monitor for downlink communication, wherein:
the first reception mode is associated with a first number of receive antennas at the UE, and
the second reception mode is associated with a second number of receive antennas at the UE that is different from the first number of receive antennas; and
transmitting the downlink communication to the UE based on the second reception mode.
